(19) United States
(12) Patent Application Publication
(10) Pub. No.: US 2006/0171702 A1
(43) Pub. Date: Aug. 3, 2006

(54) Method and device for recording images composing a panorama, and for viewing and modifying a panorama

(75) Inventors: Jeanne Guillou, Plougastel Daoulas (FR); Patrice Onno, Rennes (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/342,597

(22) Filed: Jan. 31, 2006

(30) Foreign Application Priority Data
Feb. 1, 2005 (FR) 0500993

(51) Int. Cl. G03B 17/24

(52) U.S. Cl. 396/310

(57) ABSTRACT

A method of recording images composing a panorama in a digital image capture apparatus includes the step of capturing at least one digital image of the panorama, storing the at least one captured image, and inserting information of the at least one captured digital image in a composition descriptor of the panorama including information relating to the different images composing the panorama. The inserted information includes the position of the at least one captured digital image, that position having the coordinates of at least one predefined point of the at least one captured digital image in the panorama and, for at least one region of overlap between at least the captured digital image and at least one adjacent digital image of the panorama, at least one dimension of the region of overlap.

### FIELD OF THE INVENTION

The invention concerns a method and a device for recording images composing a panorama in a digital image capturing apparatus, as well as a method and a device for viewing a panorama composed of digital images and a method and device for modifying such a panorama.

The present invention generally relates to the mode of shooting panoramas by digital image capturing apparatuses, and in particular digital cameras.

### BACKGROUND OF THE INVENTION

Digital image capturing apparatuses provide an image shooting mode referred to as “panorama”. This shooting mode makes it possible to capture contiguous digital images of the same landscape.

The different digital images forming the panorama are stored independently in a memory space of the digital image capture apparatus. The term “memory space” is used to mean a permanent memory, for example a memory card, a Flash memory, a hard disk, etc.

The panorama is in reality formed by means of a software application on a micro-computer. For this, the digital images stored in the memory space of the digital image capture apparatus must be transferred to the micro-computer for processing.

Software applications are now capable of creating the image of the final panorama on the basis of the different digital images belonging to the same panorama.

The modification of such a panorama, once created, may be performed by deleting a digital image stored in the memory space of the digital image capture apparatus, by replacing it with a new independent shot and by regenerating the image of the panorama using the software application.

The “panorama” mode of an digital image capture apparatus consists of providing the user with means ensuring for him that the images composing the panorama are correctly positioned with respect to each other.

These means consist of a shooting aid which, during the creation of the panorama, enables the position of the new image to be set with respect to the latest image or images stored.

However, during the modification of a panorama so created, i.e. during the replacement of one image of the panorama with a new image, the digital image capture apparatus in no way provides the aid for making the current shot enabling the position of the new image to be set with respect to an image already stored belonging to that panorama.

This is because the images forming a panorama are independent from each other within the digital image capture apparatus.

Nothing therefore makes it possible for the user to ensure that the digital images forming the panorama after modification are correctly positioned with respect to each other.

For this reason, solutions have been proposed with the aim of providing the user with the possibility of modifying a panorama while ensuring that the different shots forming the panorama are correctly positioned with respect to each other.

Thus, there is known, for example, according to the patent U.S. Pat. No. 6,704,465, a method of managing the file names on a digital camera which makes it possible to determine, a posteriori, certain information relating to the digital images constituting a panorama.

According to this method, it is possible to determine the images forming the same panorama by means of the file names of the images captured and recorded.

Furthermore, the file names indicate the respective positions of the digital images in the panorama.

This method is based on a particular syntax for naming the files of each of the digital images.

The syntax is defined for each possible configuration of panorama.

Different configurations of panorama are, for example, three successive images from right to left or three successive images from top to bottom, or four images arranged in a square.

According to a configuration example comprising four images arranged in a square, the files corresponding to the four shots are named P10-3635.JPG, P11-3636.JPG, P01-3637.JPG and P00-3638.JPG.

The syntax used for naming the different digital images forming a panorama makes it possible, with the letter P, to define that the set of these digital images belong to the same panorama. The two figures following the letter P give the position of the digital image in the panorama. The first figure corresponds to the line, and the second figure, to the column of the image in the panorama.

Thus, the file named P10-3635.JPG represents the image at bottom left of the panorama formed from four images arranged in a square.

However, this method only has a syntax for naming the file names of the images captured and recorded composing a panorama, but does not provide a solution for modifying one of the images constituting a panorama, while aiding the user to shoot new views. Furthermore, the definition of this syntax only describes a proprietary solution.

Moreover, from the patent U.S. Pat. No. 6,661,455 a method is known of storing information of captured digital images composing a panorama for the purpose of viewing the final panorama.

This patent provides for the modification of certain parameters of the panorama, in particular the possibility of deleting an image constituting the panorama.

In certain cases, this deletion induces the division of the panorama into two panoramas.

Thus, if a panorama is composed of four successive images from left to right, the deletion of the image present in the second position leads to the formation of two panoramas: the first panorama is composed of a single image, and the second panorama is composed of two images.

The drawback of this method is not being able to replace a deleted image belonging to a panorama.

### SUMMARY OF THE INVENTION

The present invention is directed, firstly, to a method of recording images composing a panorama in a digital image capture apparatus. The method comprises the following steps:

capturing at least one digital image of the panorama;

storing said at least one captured image;

inserting information of said at least one captured digital image in a composition descriptor of the panorama comprising information relating to the different images composing the panorama, said inserted information comprising:
the position of said at least one captured digital image, that position comprising the coordinates of at least one predefined point of said at least one captured digital image in the panorama and,
for at least one region of overlap between at least said captured digital image and at least one adjacent digital image of the panorama, at least one dimension of said region of overlap.

This new method of recording is, in particular, based on the updating, in the digital image capture apparatus, of a composition descriptor of a panorama during the capture of each new image composing the panorama.

This updating is in particular performed by insertion in the descriptor of position information of each new image within the panorama, for example, of the coordinates of at least one point of each image.

Such a descriptor may thus be used for viewing a preview of the final image of the panorama directly in the image capturing apparatus, without action by the user.

Furthermore, in case of modification of the panorama in the image capturing apparatus, the descriptor provides the information necessary for assisting with the capture of a new image in particular by aiding the user to adjust the position of that image with respect to the adjacent images of the panorama.

According to another feature, that position comprises the coordinates of one of the corners of said at least one captured digital image.

The use of these coordinates in the descriptor enables each image to be positioned in the final panorama

According to another feature, the information inserted further comprises the height and the width of said at least one captured digital image.

According to this feature, it is, furthermore, possible to know the size of the images composing the panorama, by virtue of the descriptor.

According to one feature, said inserted information comprises, for each region of overlap between at least said captured digital image and at least one adjacent digital image of the panorama, at least one dimension of said region of overlap.

The dimension information of the region of overlap makes it possible to know the region of an image overlapping with a contiguous image, that region having to be displayed for example only once during viewing of the panorama, i.e. that region will only be displayed by one of the contiguous images.

According to another feature, the composition descriptor of the panorama further comprises information on the size of the panorama.

According to this feature, it is possible to display the preview of the final panorama, in particular on an LCD display, or to print that panorama without however recalculating its size each time it is displayed.

According to another feature, at least one reference table of the digital images composing the panorama is associated with said panorama.

According to this feature, the image data are distributed between the reference tables, which makes it possible to distribute the images composing the panorama between different physical media. For example, one or more images of the panorama may be stored on a hard disk and one or more others in a Flash memory.

According to another feature, said at least one reference table comprises the number of images composing the panorama and an access address to each stored digital image composing the panorama.

The reference table comprises the information enabling the number of stored images of the panorama and the address of each of those images to be identified.

According to another feature, at least one fragment table is associated with said panorama, said at least one fragment table comprising references to the fragments of data of each stored digital image composing the panorama.

According to this feature, the image data are distributed between the fragment tables identifying the different segments of data composing the panorama.

According to another feature, said at least one fragment table further comprises the number of data fragments of images composing the panorama and, for each fragment:

the access address to the stored digital image comprising the fragment;

the address of the data constituting the stored fragment; and

the length of the data.

According to another feature, prior to capturing said at least one digital image, the method comprises a step of displaying at least one region of at least one adjacent digital image of the panorama and which was stored in advance, said at least one region being adapted to constitute at least one region of overlap between said at least one adjacent digital image and said at least one image to capture.

According to this feature, the recording method thus provides an aid to shooting contiguous images, by facilitating the later placing of the position of the images composing the panorama.

According to another feature, the composition descriptor of the panorama is stored in a computer file.

According to another feature, said file further comprises said at least one reference table.

According to another feature, said file further comprises said at least one fragment table.

According to another feature, the computer file is a file in accordance with the JPX extension of the JPEG2000 standard.

This is a standardized format that the different image reading software applications are able to read.

The present invention also concerns a method of viewing a panorama composed of recorded digital images, the images being recorded in accordance with the aforementioned recording method. The viewing method comprises the following steps:

extracting from the composition descriptor of the panorama the position information of each of the digital images composing the panorama;

displaying the digital images composing the panorama on the basis of the extracted position information, for the purpose of viewing the panorama.

The viewing method is in particular based on the information contained in the descriptor. This is because the latter comprises information on the images composing the panorama, as well as on the position of each of the images by means of the coordinates of at least one point of each of the digital images in the panorama. This information makes it possible to reconstruct the panorama and to display a preview of the final image of the panorama, without action by the user.

The present invention further concerns a method of modifying a panorama composed of recorded digital images, in an image capture apparatus, the images being recorded in accordance with the aforementioned recording method. The modifying method comprises the following steps:

extracting from the composition descriptor of the panorama the position information of each of the digital images composing the panorama;

displaying the digital images composing the panorama on the basis of the extracted position information, for the purpose of viewing the panorama;

selecting at least one of the displayed digital images composing the panorama;

recording at least one other digital image according to said recording method, said at least one other recorded digital image replacing said at least one of the selected digital images.

The method of modifying a panorama, according to the invention, provides for using, in the image capture apparatus, the information of the descriptor in order to display the image of the panorama and then to capture and record a new replacement image.

According to one feature, the replacement further comprises the replacement of the information of said at least one selected digital image, which information is present in the composition descriptor of the panorama, by the information of said at least one other recorded digital image.

The present invention is also directed to a device for recording images composing a panorama in a digital image capture apparatus. The device comprises:

means for capturing at least one digital image of the panorama;

means for storing said at least one captured image;

means for inserting information of said at least one captured digital image in a composition descriptor of the panorama comprising information relating to the different images composing the panorama, said inserted information comprising:
the position of said at least one captured digital image, that position comprising the coordinates of at least one predefined point of said at least one captured digital image in the panorama and,
for at least one region of overlap between at least said captured digital image and at least one adjacent digital image of the panorama, at least one dimension of said region of overlap.

This device has the same advantages as the method of recording images composing a panorama in a digital image capture apparatus briefly described above and these will therefore not be reviewed here.

The present invention is also directed to a device for viewing a panorama composed of digital images recorded by means of the recording device in accordance with the invention. The device comprises:

means for extracting the position information of each of the digital images composing the panorama from the composition descriptor of the panorama;

means for displaying the digital images composing the panorama on the basis of the extracted position information, for the purpose of viewing the panorama.

This device has the same advantages as the method of viewing a panorama composed of recorded digital images briefly described above and these will therefore not be reviewed here.

The present invention is further directed to a device for modifying a panorama composed of digital images recorded by means of the recording device in accordance with the invention, in a digital image capture apparatus. The device comprises:

means for extracting the position information of each of the digital images composing the panorama from the composition descriptor of the panorama;

means for displaying the digital images composing the panorama on the basis of the extracted position information, for the purpose of viewing the panorama;

means for selecting at least one of the displayed digital images composing the panorama;

means for replacing said at least one of the selected digital images by at least one other digital image recorded by said recording device.

This device has the same advantages as the method of modifying a panorama composed of recorded digital images briefly described above and these will therefore not be reviewed here.

According to other aspects, the invention also concerns computer programs for an implementation of the methods of the invention described briefly above as well as a digital image capture apparatus.

Other aspects and advantages of the present invention will appear more clearly on reading the description of the embodiments which follows.

### BRIEF DESCRIPTION OF THE DRAWINGS

FIG. 1a illustrates a first shot of a digital image, the image being the first image of the panorama;

FIG. 1b illustrates the shot of the second image of the panorama, the second image being made by means of the shooting wizard enabling the second image to be positioned;

FIG. 1c illustrates the region of overlap between the first and the second image of the panorama;

FIG. 1d illustrates the viewing of the panorama once created;

FIG. 2 represents an algorithm of the method of recording images composing a panorama according to the invention;

FIG. 3a represents the structure of a file according to the JPX standard;

FIG. 3b illustrates the different parameters stored in the JPX file;

FIG. 4 illustrates the fragmentation of a JPX file into several files;

FIG. 5 illustrates an example of a JPX file further to making the different shots of the images composing the panorama;

FIG. 6 represents an algorithm of the method of panorama viewing according to the invention;

FIG. 7 represents an algorithm of the method of panorama editing according to the invention;

FIG. 8a illustrates a panorama composed of two images;

FIG. 8b illustrates the selection of an image of the panorama for the purpose of replacing it;

FIG. 8c illustrates the replacement of the image selected in FIG. 8b;

FIG. 8d illustrates the panorama of FIG. 8a further to its modification;

FIG. 9 is a diagram of a digital camera in which the invention is implemented.

### DETAILED DESCRIPTION

A description will first of all be given of the capture of digital images in panorama mode which is implemented in digital cameras.

Panorama mode has the advantage of facilitating the capture of contiguous digital images of the same landscape.

For this, shooting aid means enable the user to correctly position and capture a digital image with respect to another image already captured of the same panorama.

When these digital images are transferred onto a micro-computer, an image processing software application creates a single digital image, i.e. the final panorama on the basis of the contiguous images.

To obtain a satisfactory result, the images must contain a common region, for example by containing a notable item.

This common region enables the software creating the final panorama to detect the parts in common between the images composing the panorama and thus provides a better repositioning of the different images.

By virtue of this panorama wizard, the panorama mode of the digital camera displays the region in common between the contiguous images at the time of the capture of the digital images belonging to the same panorama.

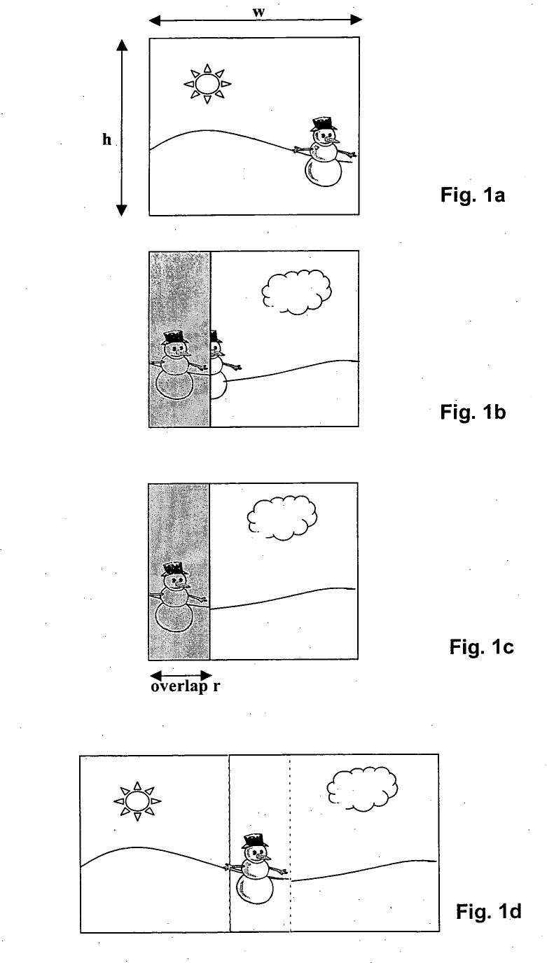

FIGS. 1a, 1b, 1c and 1d illustrate the creation of a panorama by means of a digital camera.

In this example, the configuration chosen of the panorama is a horizontal configuration.

However, the configuration of the panorama may be vertical or be composed of N vertical images by M horizontal images, N and M being any integers greater than or equal to 1.

When the current mode of a digital camera is used, that is to say that no particular mode is selected, the liquid crystal display of the digital image capture apparatus gives a real-time reproduction of the image pointed at.

In panorama mode, during the shooting of the first image composing the panorama, the current mode is applied.

FIG. 1a illustrates the viewing of the image which will be captured on the liquid crystal screen. After capture by means of an image shooting circuit, an image is obtained, recorded under the name “image0” of width w and height h. Conventionally, the compression format is the JPEG format, but other compression formats may be used such as JPEG2000 format.

On capture of the following images of the panorama, the left part of the liquid crystal screen no longer displays the shooting in real time, but displays a fixed part representing the right part of the preceding image (FIG. 1a) as illustrated in FIG. 1b.

On the other hand, the other part of the screen, i.e. the right part, gives a real-time display of the image pointed at.

The presence of the fixed part representing the right part of the preceding image enables the user to adjust his position of capture so as to make the left part of the capture match the right part of the preceding image.

Thus, the two images have a common region, also called region of overlap, corresponding to the fixed region of the screen.

After the user has set the position of the image viewed in real time, the image may be captured by means of the image shooting circuit in order to obtain a digital image recorded under the name “image1” and which is illustrated in FIG. 1c.

The second image captured has the same format as the first image named “image0” and, on the left part of the image, has a region of overlap of width r with the first image.

The digital images are then stored independently in a memory space of the digital camera.

The viewing mode of the digital camera makes it possible to display each of the recorded images on the liquid crystal screen.

After capture of the different images composing the panorama, those images will be transferred to a micro-computer.

After processing of the different images composing the panorama by a software application, in particular by finely readjusting the images, the final panorama as illustrated in FIG. 1d is available.

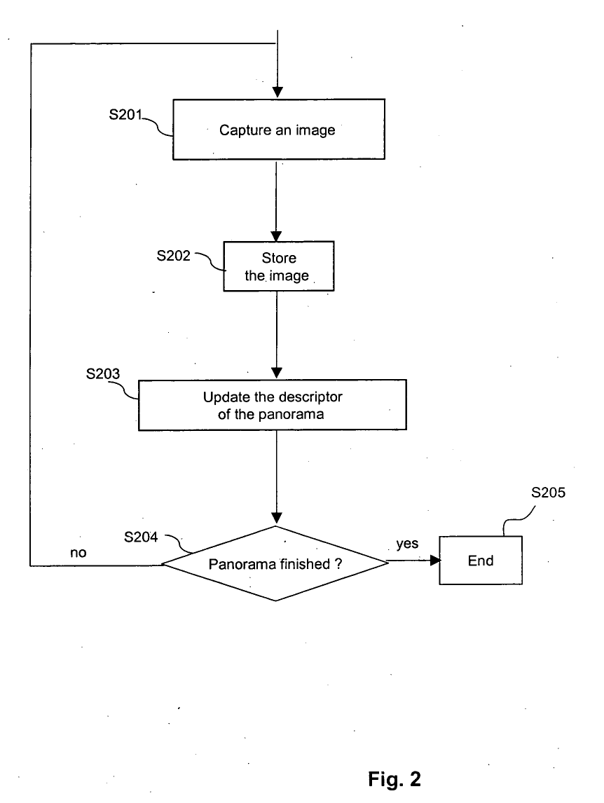

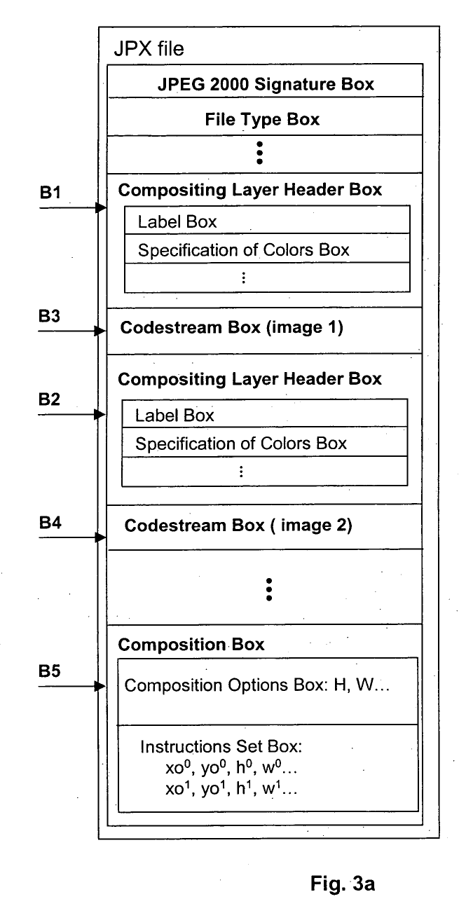

FIG. 2 illustrates an algorithm for recording images composing a panorama and which enables the information relating to the composition of the panorama according to the invention to be stored.

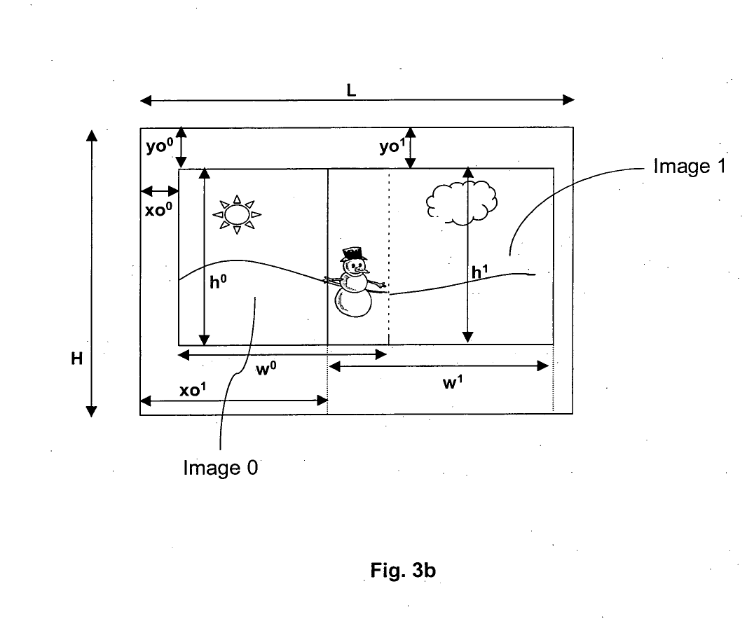

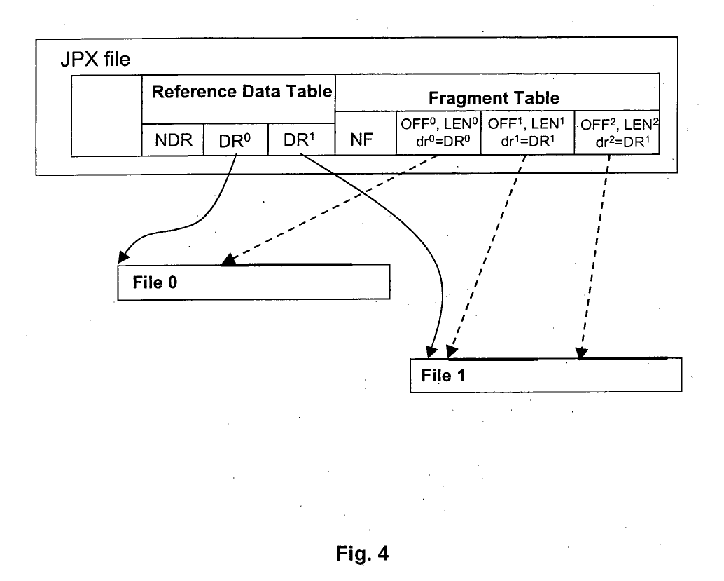

The details of certain aspects of the recording of images composing a panorama is also illustrated in FIGS. 3a and 4 which will be described below.

The recording algorithm illustrated in FIG. 2 comprises a first step S201 of capturing a digital image as illustrated in FIG. 1a.

After performing the capture, the digital image is compressed and stored, at step S202, in a memory storage space of the digital camera.

Step S202 is followed by step S203 consisting of updating the composition information of the panorama. For this, there is associated with each panorama a descriptor comprising information relating to the different images composing the panorama. The information comprises, in particular, the position of each captured image in the panorama, in particular, the coordinates of a predefined point of the digital image in the panorama, for example, the coordinates of the top left corner of the digital image.

The predefined point may also be a point situated at the center of the image.

Said information may further comprise the height and the width of each digital image captured.

Thus, during step S203, at least some of the aforesaid information relating to the image which has just been captured is inserted in the descriptor.

Step S203 is then followed by step S204, in order to determine whether the panorama has been finished. This step may be carried out, for example, by consulting the user.

In the affirmative, the algorithm is terminated at step S205.

In the opposite case, the algorithm continues by reiterating steps S201 to S204.

Thus, the panorama is constructed progressively as the different digital images are captured.

During capture of the different images, the descriptor of the panorama will maintain an item of information concerning, in particular, the size of the panorama.

Similarly, as seen earlier, the different images composing the panorama comprise one or more regions of overlap between the images, and the descriptor may also include the information on the size of the regions of overlap between the different images.

Thus, using the information contained in the descriptor of a panorama, it is possible both to identify the composition of the panorama, as well as to construct and rapidly view the final panorama.

Furthermore, on transfer of the images of a panorama and of the associated descriptor, the software application for creating the image of the final panorama has available all the information enabling it to create the final panorama without requiring action by the user.

It should be noted that the images captured by a digital camera are recorded in a file, for example in JPEG or JPEG2000 format, and stored in a memory space of the digital camera.

For further information concerning JPEG2000 format, the reader may in particular refer to the standard “JPEG 2000 coding system: Core technologies”, Part I, International Standard, ISO 15444-1.

The JPEG2000 standard also defines an image file format called JPX of which the specification is provided in the following reference: “JPEG2000 coding system: Extensions”, Part II, International Standard ISO 15444-2.

A JPX file is composed of a collection of boxes, of which some of the boxes are independent and others of the boxes contain other boxes, each box specifying various information.

This format has been defined in order to enable interoperability between the applications using those files.

According to the invention, an implementation of the descriptors using the JPX format relies, in particular, on the use of two options specific to the JPX file.

The first option consists of storing several images in the same file, while specifying the display parameters of each image.

The second option consists of fragmenting the image data into several files.

By way of illustration of the first option, FIG. 3a represents a JPX file comprising the data of two images composing a panorama, and FIG. 3b illustrates the display of the parameters of the images of the panorama corresponding to that file.

The second option is illustrated in FIG. 4, which represents a JPX file when the image data are fragmented into external files (files 0, 1 etc.) As illustrated in FIG. 3a, in the context of a JPX file, the information relating to each digital image of a panorama constitute a compositing layer.

A compositing layer, in simplified terms, is an image obtained, for example, by decompressing the R, G and B data of a file.

For each compositing layer, header data specific to that layer are stored in the box called Compositing Layer Header box.

In FIG. 3a, boxes B1 and B2 represent the headers of two compositing layers, managing the information relating to two digital images of the panorama.

Thus, for each compositing layer, specific data are defined comprising, for example, a title, information on the color space of the decoded digital image, and information on the opacity of the image.

Next, the encoded data of an image corresponding to a compositing layer are contained in the boxes called contiguous codestream boxes.

In FIG. 3a, boxes B3 and B4 represent the encoded data of the two digital images of the panorama.

A JPX file also comprises a composition box.

This box comprises a description of the combination of the compositing layers necessary for the creation of the panorama for the purpose of displaying it.

In FIG. 3a box B5 represents such a composition box.

The box is composed of a sub-box comprising a set of overall options, termed “Composition Options Box” and of one or more sub-boxes termed “Instruction Set Boxes” each comprising a set of display instructions.

The “Composition Options Box” specifies the value of a certain number of parameters such as the size information of the panorama, in particular, the height of the final panorama and the length of the final panorama.

The size information of the panorama corresponds, for example, to the sum of the size information of each digital image composing the panorama. Where there are regions of overlap between the digital images composing the panorama, the sum of the size information of each region is reduced by at least one dimension of each region of overlap.

FIG. 3b illustrates, with the titles H and W, the total height and the total width of the image composition, i.e. of the panorama.

As indicated above, the composition box B5 comprises one or more boxes termed “Instruction Set Boxes”, each box being associated with a compositing layer, i.e. a digital image composing the panorama.

Each box termed “Instruction Set Box” comprises a certain number of parameters.

First of all the parameter xoⁱ designated “horizontal offset” provides the x-coordinate of the top left corner of a compositing layer in the display region of the panorama.

Thus, in FIG. 3b, the parameters xo⁰ and xo¹ represent the x-coordinate of the top left corner respectively of the image 0 and the image 1 of the panorama.

The parameter yoⁱ designated “vertical offset” provides the y-coordinate of the top left corner of a compositing layer in the display region of the panorama.

In FIG. 3b, the parameters yo⁰ and yo¹ represent the y-coordinate of the top left corner respectively of the image 0 and the image 1 of the panorama.

The compositing layer width parameter, designated “Iⁱ” gives the width of the ith image of the panorama.

Thus, in FIG. 3b, the parameters I⁰ and I¹ represent respectively the width of the image 0 and of the image 1 of the panorama.

The compositing layer height parameter, designated “hⁱ” represents the height of the ith image of the panorama.

Thus, in FIG. 3b, the parameters h⁰ and h¹ represent respectively the height of the image 0 and of the image 1 of the panorama.

The parameter defining the horizontal section xcⁱ provides the horizontal distance of the desired portion of the compositing layer from the left side of that layer, this parameter defining the vertical region of overlap of the image considered (the ith image) with the left image in the panorama. This image portion will not be taken into account in the construction of the panorama.

The parameter defining the vertical section ycⁱ provides the vertical distance of the desired portion of the compositing layer from the top side of that layer, this parameter defining the horizontal region of overlap of the image considered (the ith image) with the top image in the panorama. This image portion will not be taken into account in the construction of the panorama.

The parameter of width of section wcⁱ provides the width of the desired portion of the compositing layer i.e. the portion of the image considered (the ith image) on forming the panorama. Thus, the section width wcⁱ is the width of the compositing layer reduced by the size of the region of overlap.

Finally, the parameter of height of section hcⁱ provides the height of the desired portion of the compositing layer i.e. the portion of the image considered in height (the ith image) necessary for forming the panorama. Thus, the height of the section hcⁱ is the height of the compositing layer reduced by the size of the region of overlap.

Thus, as illustrated in FIGS. 3a and 3b, a JPX file can contain data for several images and parameters determining the display of each of those images within the panorama.

According to the invention, a reference table can be associated with a panorama. The table is either included in the descriptor, or is separate. Its purpose is to store the files of the digital images composing a panorama.

Thus, the reference table comprises the access address to each of the images composing the panorama.

It may also store the number of images in the panorama considered.

According to a variant, a fragment table can also be associated with a panorama. The table is either included in the descriptor, or is separate. Its purpose is to store the references to the different data fragments of each image composing the panorama.

For this, the fragment table comprises, for example, for each data fragment, the access address to the file containing the stored digital image which comprises the fragment, the address in that file of the data constituting the stored fragment, and the length of the segment in a fragment, that is to say the length of the data.

The fragment table may further comprise the number of image fragments composing the panorama.

FIG. 4 illustrates a JPX file in which the image data are fragmented in external files.

The JPX file first of all contains a reference data table and then a fragment table.

The first table, i.e. the reference data table, specifies, in particular, the number of references NDR to external files containing the encoded data of a digital image, as well as an address to each of the references, i.e. to the external files DRⁱ.

In FIG. 4, the value of NDR is 2. Reference DR⁰ points to the address of the first file “File 0” and the reference DR¹ points to the address of the second file “File 1”.

Next, the second table or fragment table specifies, first of all, the number of fragments denoted NF. In FIG. 4, the number of fragments NF has the value 3.

The fragment table also specifies for each fragment j, the address parameter of the data OFF^{j} in the file, the length of the data of the fragment LEN^{j}, and the parameter dr^{j} identifying in the reference data table, the reference DRⁱ corresponding to the file in which the fragment is found.

After combination of this information, the data specified in the fragment table form a complete and valid codestream.

This form of representation of a JPX file thus makes it possible to have data distributed between different files.

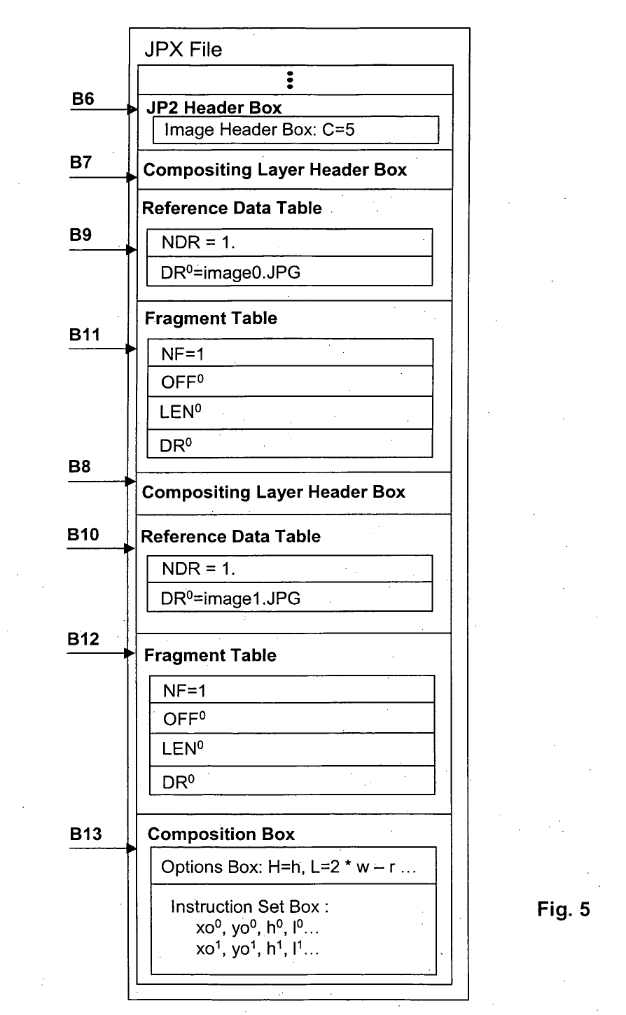

FIG. 5 illustrates the JPX file created for the panorama of FIG. 1d.

As represented in FIG. 5, the JPX file contains a first JP2 Header Box B6. This JP2 header box itself comprises a JP2 Image Box.

The JP2 header box specifies the parameter C defining the type of encoding used for the digital image data.

In the context of digital images captured by means of a digital camera, the data are encoded in JPEG format.

According to the JPX standard, the JPEG encoding mode defined by the parameter C takes the value 5, and it would take the value 7 for the JPEG2000 encoding mode.

As described earlier, for each of the images composing the panorama, a JPX file may comprise a Compositing Layer Header box (B7 and B8), a reference data table (B9 and B10) and a fragment table (B11 and B12).

Each of these reference tables B9 and B10 comprises a single reference. Thus, the value of the parameter NDR (first field) takes the value 1 since each digital image is recorded in a file.

The second field of the reference data table of the first image B9 comprises the reference DR⁰ of the first image named image0.JPG.

Similarly, the second field of the reference data table B10 corresponding to the second image, comprises a reference DR⁰ giving the address of the second image named image1.JPG.

Concerning the fragment tables B11 and B12, these each comprise a single fragment corresponding to the bitstream of each JPG image.

Thus, for each fragment table, the value OFF⁰ is thus zero, and the value LEN⁰ corresponds, respectively, to the length in kilobytes of the image image0.JPG and of the image image1.JPG.

The file JPX of FIG. 5 also comprises a composition box B13 which describes the arrangement of the images in the panorama.

A description will now be given, with reference to FIG. 1d, of an example illustrating the different parameters of the Composition Options Box indicated in FIG. 5.

For this, the parameter H takes the value h reflecting the overall height of the panorama illustrated in FIG. 1d.

The parameter L reflecting the overall width of panorama takes the value (2*w−r) where w represents the width of an image and r the region of overlap between the first image and the second image of the panorama.

Thus, when the different digital images composing the panorama are adjusted with respect to each other, the size information of the panorama corresponds to the sum of the size information of each image composing the panorama, which may be reduced by at least one dimension of each region of overlap between the different digital images composing the panorama in case there is a region of overlap, as illustrated in FIG. 1d.

A description is given below of the content of the first box named Instruction Set Box corresponding to the first compositing layer, i.e. to the first image named image0.JPG.

The parameter xo⁰ named “horizontal offset” and the parameter yo⁰ named “vertical offset” respectively define the x-coordinate and y-coordinate of the upper left corner of the first compositing layer, i.e. of the first image, each taking the value 0 thereby showing that the image concerned is positioned in the top left corner of the panorama.

Next, the parameters defining the width and the height of the compositing layer, i.e. of the image, and which are represented by the parameters I⁰ and h⁰ respectively take the values w and h.

This is because, as illustrated in FIG. 1a, the first image is of height h and width w.

Next, the parameters xc⁰ and yc⁰ indicating the horizontal section and the vertical section of the compositing layer considered, i.e. of the first image, each take the value zero.

This is because the image portion to consider is situated at a zero horizontal and vertical distance from the top left corner of the image considered.

Finally, the parameters wc⁰ and hc⁰ representing the height and the width of the image considered, respectively take the values w and h since there is no region of overlap to delete from that image.

The second box named “Instruction Set Box” corresponding to the second compositing layer, i.e. to the second image composing the panorama, will now be described.

The parameters xo¹ and yo¹ representing the x-coordinate and the y-coordinate of the top left corner of the second compositing layer, i.e. of the second image, respectively take the values w−r and 0.

This is because the second image is positioned in the panorama at a distance w−r from the top left corner of the panorama and at a distance 0 along the y-axis.

As regards a horizontal panorama, the top left corner of the second image has a y-coordinate equal to zero.

Next, the width parameters I¹ and height h¹ of the compositing layer respectively take the values w and h.

Next, the parameters xc¹ and yc¹ representing the horizontal and vertical section respectively take the value r and the value 0.

This is because the image portion to consider is situated at a horizontal distance r and vertical distance zero from the top left corner of that image.

This is because the image portion to consider is situated at a horizontal distance xc⁰ from the top left side of that layer in the composition of the panorama. This distance takes the value r corresponding to the width of the image's region of overlap to be deleted.

Next, the parameters wc¹ and hc¹ representing the width and the height of the section take respectively the value w−r and the value h since the image considered at the time of the composition is of size w−r and h.

It is thus possible to construct the panorama by means of the set of those parameters contained in a file, for example a JPX file. This is because the set of the position information of each of the images of the panorama is known, as well as the regions of overlap between each of the images.

Using the aforementioned information, viewing the panorama becomes easy.

The set of this information makes it possible to view a first rough representation of the panorama providing the user a first idea of the reproduction of his panorama.

In order to obtain a final version of the panorama, processing on a computer may remain necessary to refine the readjustment of position between the different images composing the panorama.

Using the information, it is now possible to add a new mode to digital cameras, i.e. a viewing mode.

Furthermore, by means of the information of the descriptor of each of the images composing the panorama, it is also possible to add a panorama modification mode to digital cameras, while providing the user with the shooting aid with respect to the other images composing the panorama.

Similarly, the descriptor comprising the set of the panorama composition information, makes it possible, once the images have been transferred to a computer, to automatically create the image of the final panorama without the user having to indicate to the software application the images constituting the panorama, as well as their respective position.

Furthermore, during the use of the JPX file, as this is in accordance with a standard, the data may potentially be understood and used by any software application.

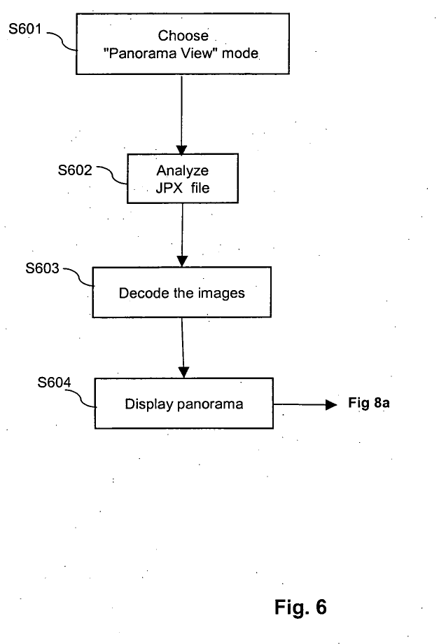

With reference to FIG. 6, a description will now be given of a viewing algorithm for the panorama.

This algorithm uses the information available from the descriptor associated with the panorama and which was described earlier.

The algorithm starts at step S601 by the activation of the “panorama view” mode.

Step S601 is followed by step S602 which consists of analyzing the descriptor, in particular on the basis of the JPX file.

For this, the parameters of the “Composition” box are extracted as well as the reference of each image constituting the panorama. These parameters will be used for producing a preview of the panorama to display on the digital camera.

During the following step S603, the images corresponding to the references extracted at step S602 are decoded.

Step S603 is followed by step S604 consisting of producing the preview of the panorama on the basis of the information extracted at step S602, then of displaying that preview on the liquid crystal screen of the digital camera.

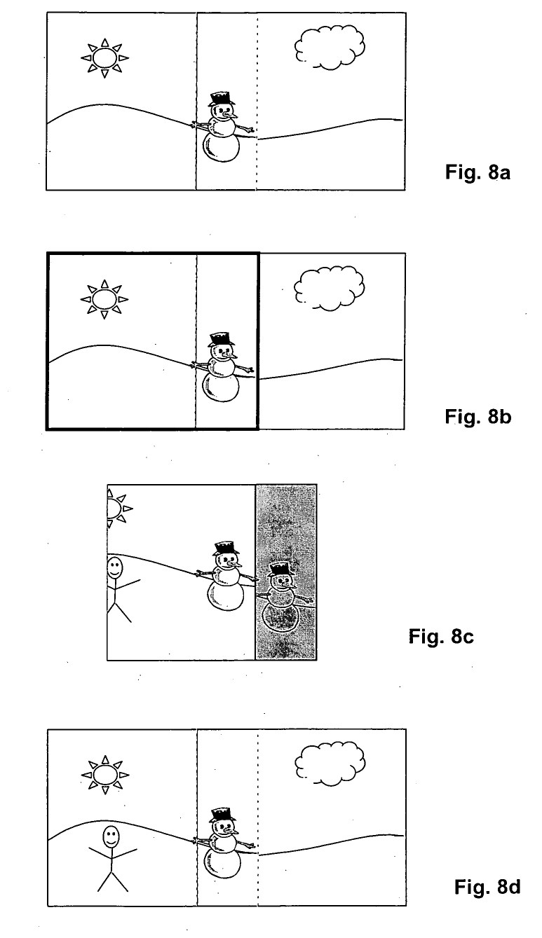

FIG. 8a illustrates the result of the preview of the panorama which is displayed. This provides a final or practically final preview of the panorama and not a justaposition of the images composing the panorama.

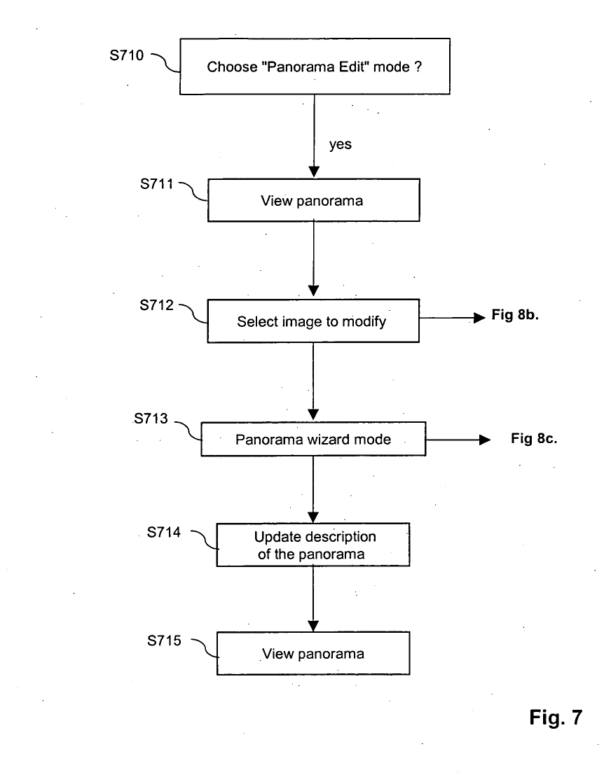

With reference to FIG. 7, a description will now be given of a modifying algorithm for the panorama. This algorithm uses the information available from the descriptor associated with the panorama and which was described earlier.

The algorithm starts at step S710 by the activation of the “panorama edit” mode for modifying a panorama.

Step S710 is followed by step S711 consisting of viewing the panorama obtained by steps S602 to S604 of FIG. 6 already described.

Step S711 is next followed by the step S712 during which the user will select an image to modify.

FIG. 8b illustrates the selection of an image of the panorama of which the preview had been displayed on the liquid crystal screen of the digital camera as illustrated in FIG. 8a. For selecting an image to delete in order to replace it, a frame that is visible to the user surrounds that image.

The user can then modify the image that is selected (i.e. surrounded by the frame) by virtue of a conventional interface of the digital camera (for example using direction arrows).

After the user has confirmed his selection of an image, the latter is deleted.

Step S712 is followed by step S713 during which the “panorama wizard” mode is reactivated in order to provide the user with the aid for capturing the new image.

For this, the information contained in the descriptor of the panorama, for example stored in a JPX file, is used.

The screen of the digital camera is then divided into two parts. The first part of the screen represents the image pointed at by the camera in real time. The second part of the screen represents the region of overlap of the image to capture with the contiguous image

Thus, the user may adjust the position of his image to be captured on this region of overlap as illustrated by FIG. 8c.

According to this example, the image to modify is the first image of the panorama. Thus, on the left part of the screen of the digital camera, the panorama wizard displays the real-time shooting and, on the right part of the screen, the left part of the second image of the panorama (grayed part) in FIG. 8c. The user can thus set the position of his new shot.

Step S713 is followed by step S714 consisting of updating the descriptor of the panorama. For this, updating is performed, for example, of the JPX file associated with the panorama.

This updating takes into account the updating of the new reference of FIG. 4, as well as of the composition box of FIG. 3a.

Step S714 is followed by step S715, similar to step S711, and which consists of displaying the new preview of the modified panorama.

FIG. 8d illustrates the display of the new panorama.

According to a specific embodiment, steps S601 to S604 are followed by a choosing step giving the user the possibility of choosing the “panorama edit” mode, by means of a conventional interface of the digital camera, for example using a “menu key” enabling the options available at the current step to be displayed on the liquid crystal display.

Thus, if the “panorama edit” mode is selected, the algorithm continues via steps S712 to S714.

The digital images and the descriptor associated with a panorama may then be transferred to a micro-computer for creation of an image of a final panorama.

The digital images and the descriptor associated with a panorama stored on a micro-computer may again be transferred to the memory space of the digital camera.

The “panorama view” and “panorama edit” modes are then accessible. An image of a panorama may then be modified while benefiting from the shooting aid.

This functionality may also be used in the case of updating panoramas.

Similarly, it is possible to continue the creation of a panorama already constituted, in particular by enlarging the panorama.

For example, it is possible, on the basis of a panorama of 3×3 configuration, to add to that panorama to obtain a 4×4 configuration by capturing seven new images.

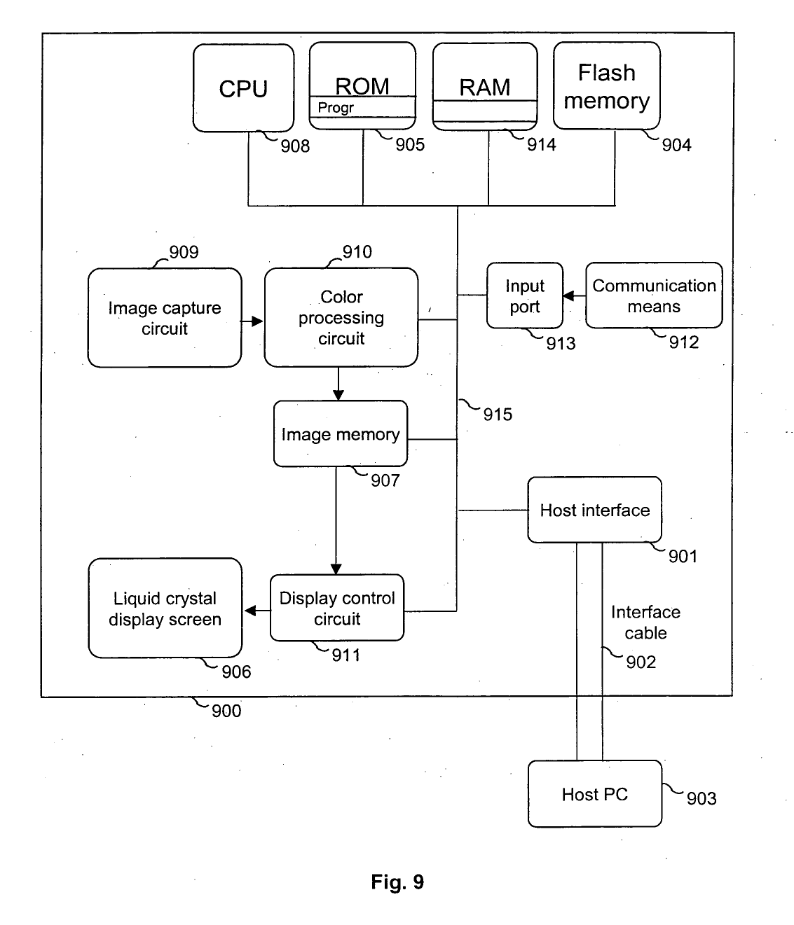

With reference to FIG. 9, a device for capturing digital images adapted to operate as a

device for recording images composing a panorama,

and/or a viewing device,

and/or a device for modifying images composing a panorama according to the invention, is described essentially in terms of its hardware configuration.

According to the embodiment chosen, the device may be, for example, a digital camera, a scanner or a printer.

Thus, the device 900 may be connected to different peripherals, for example, to a means of acquisition or storage of images or sequences of images.

The device 900 comprises, for example, a host interface 901, connected via an interface cable 902 to micro-computer 903, the interface cable being adapted to send digital information of the device 900 to the micro-computer 903.

The cable 902 may be, for example, in accordance with the USB (Universal Serial Bus) specification and enables the images contained in the memory of the device 900 to be imported into the micro-computer 903.

The device 900 also comprises a storage means 904 such as flash memory.

The flash memory is, for example, in the form of a card. It is used to store encoded images or encoded video sequences.

Furthermore, device 900 comprises a storage means 905 able to contain software implementation data of the invention, as well as the code of the computer program or programs on which the invention relies.

Device 900 also comprises a liquid crystal screen 906 making it possible to display an image stored in the flash memory 904 or in the image memory 907.

The central processing unit CPU 908 executes the instructions relating to the implementation of the invention, these instructions being stored in the read only memory ROM 905.

The device 900 also comprises a circuit 909 for image capture adapted to convert an optical image in a digital signal.

A color processing circuit 910 converts the digital signal coming from the image capture circuit 909 and sends it to the image memory 907.

The device further comprises a display control circuit 911 for controlling the display of the liquid crystal screen 906, the display control circuit 911 being under the control of the central processing unit 908.

Device 900 also comprises switching means 912 used by the user of the device.

The switching means 912 further comprise an open/close switch, a conversion mode switch, a power switch and an image selection switch.

The switching means communicate with the different means composing the device 900 via an input port 913.

On powering up, the program or programs according to the invention which are stored in one of the non-volatile memories, for example the ROM memory 905, is transferred to the RAM memory 914 which will then contain the executable code of the program or programs according to the invention, as well as the variables necessary for their implementation.

As a variant, the program or programs may be stored in different storage locations of the device 900.

In general terms, an information storage means, which can be read by a computer or microprocessor, integrated or not into the device, and which may possibly be removable, stores one or several programs implementing the method according to the invention

It is also possible to improve an embodiment of the invention by adding updated or upgraded processing methods sent by a communication network or loaded via a storage means of the apparatus.

A communication bus 915 enables communication between the different elements of the device 900 and the elements connected to the device.

It will be noted that the representation of the bus 915 is non-limiting.

Thus the central processing unit CPU 908 may, for example, communicate instructions to any element of the device 900, directly or via another element of the device 900.

1. A method of recording images composing a panorama in a digital image capture apparatus, wherein the method comprises the following steps:
capturing at least one digital image of the panorama;
storing said at least one captured image;
inserting information of said at least one captured digital image in a composition descriptor of the panorama comprising information relating to the different images composing the panorama, said inserted information comprising:
the position of said at least one captured digital image, that position comprising the coordinates of at least one predefined point of said at least one captured digital image in the panorama and,
for at least one region of overlap between at least said captured digital image and at least one adjacent digital image of the panorama, at least one dimension of said region of overlap.

2. A method according to claim 1, wherein said position comprises the coordinates of one of the corners of said at least one captured digital image.

3. A method according to claim 1, wherein said information inserted further comprises the height and the width of said at least one captured digital image.

4. A method according to claim 1, wherein said inserted information comprises, for each region of overlap between at least said captured digital image and at least one adjacent digital image of the panorama, at least one dimension of said region of overlap.

5. A method according to claim 1, wherein the composition descriptor of the panorama further comprises information on the size of the panorama.

6. A method according to claim 1, wherein at least one reference table of the digital images composing the panorama is associated with said panorama.

7. A method according to claim 6, wherein said at least one reference table comprises the number of images composing the panorama and an access address to each stored digital image composing the panorama.

8. A method according to claim 6, wherein at least one fragment table is associated with said panorama, said at least one fragment table comprising references to the fragments of data of each stored digital image composing the panorama.

9. A method according to claim 8, wherein said at least one fragment table further comprises the number of data fragments of images composing the panorama and, for each fragment:
the access address to the stored digital image comprising the fragment;
the address of the data constituting the stored fragment; and
the length of the data.

10. A method according to claim 1, wherein, prior to capturing said at least one digital image, the method comprises a step of displaying at least one region of at least one adjacent digital image of the panorama and which was stored in advance, said at least one region being adapted to constitute at least one region of overlap between said at least one adjacent digital image and said at least one image to capture.

11. A method according to claim 1, wherein the composition descriptor of the panorama is stored in a computer file.

12. A method according to claim 6, wherein the composition descriptor of the panorama is stored in a computer file and said file further comprises said at least one reference table.

13. A method according to claim 8, wherein the composition descriptor of the panorama is stored in a computer file said file further comprises said at least one fragment table.

14. A method according to claim 11, wherein the computer file is a file in accordance with the JPX extension of the JPEG2000 standard.

15. A method of viewing a panorama composed of digital images recorded according to the recording method of claim 1, wherein it comprises the following steps:
extracting from the composition descriptor of the panorama the position information of each of the digital images composing the panorama;
displaying the digital images composing the panorama on the basis of the extracted position information, for the purpose of viewing the panorama.

16. A method of modifying a panorama composed of digital images recorded according to the recording method of claim 1, in an image capture apparatus, wherein the method comprises the following steps:
extracting from the composition descriptor of the panorama the position information of each of the digital images composing the panorama;
displaying the digital images composing the panorama on the basis of the extracted position information, for the purpose of viewing the panorama;
selecting at least one of the displayed digital images composing the panorama;
recording at least one other digital image according to said recording method, said at least one other recorded digital image replacing said at least one of the selected digital images.

17. A method according to claim 16, wherein the replacement further comprises the replacement of the information of said at least one selected digital image, which information is present in the composition descriptor of the panorama, by the information of said at least one other recorded digital image.

18. A device for recording images composing a panorama in a digital image capture apparatus, wherein the device comprises:
means for capturing at least one digital image of the panorama;
means for storing said at least one captured image;
means for inserting information of said at least one captured digital image in a composition descriptor of the panorama comprising information relating to the different images composing the panorama, said inserted information comprising:
the position of said at least one captured digital image, that position comprising the coordinates of at least one predefined point of said at least one captured digital image in the panorama and,
for at least one region of overlap between at least said captured digital image and at least one adjacent digital image of the panorama, at least one dimension of said region of overlap.

19. A device according to claim 18, wherein said inserted information comprises, for each region of overlap between at least said captured digital image and at least one adjacent digital image of the panorama, at least one dimension of said region of overlap.

20. A device according to claim 18, wherein at least one reference table of the digital images composing the panorama is associated with said panorama.

21. A device according to claim 20, wherein said at least one reference table comprises the number of images composing the panorama and an access address to each stored digital image composing the panorama.

22. A device according to claim 20, wherein at least one fragment table is associated with said panorama, said at least one fragment table comprising references to the fragments of data of each stored digital image composing the panorama.

23. A device according to claim 22, wherein said at least one fragment table further comprises the number of data fragments of images composing the panorama and, for each fragment:
the access address to the stored digital image comprising the fragment;
the address of the data constituting the stored fragment; and
the length of the data.

24. A device according to claim 18, wherein the device further comprises means for displaying at least one region of at least one adjacent digital image of the panorama and which was stored in advance, said at least one region being adapted to constitute at least one region of overlap between said at least one adjacent digital image and said at least one image to capture.

25. A device according to claim 18, wherein it comprises means for storing the composition descriptor of the panorama in a computer file.

26. A device for viewing a panorama composed of digital images recorded by the recording device of claim 18, wherein the device comprises:
means for extracting the position information of each of the digital images composing the panorama from the composition descriptor of the panorama;
means for displaying the digital images composing the panorama on the basis of the extracted position information, for the purpose of viewing the panorama.

27. A device for modifying a panorama composed of digital images recorded by the recording device of claim 18, in a digital image capture device, wherein the device comprises:
means for extracting the position information of each of the digital images composing the panorama from the composition descriptor of the panorama;
means for displaying the digital images composing the panorama on the basis of the extracted position information, for the purpose of viewing the panorama;
means for selecting at least one of the displayed digital images composing the panorama;
means for replacing said at least one of the selected digital images by at least one other digital image recorded by said recording device.

28. A device according to claim 27, wherein the replacement means further comprise means for replacing the information of said at least one selected digital image, which information is present in the composition descriptor of the panorama, by the information of said at least one other recorded digital image.

29. A computer program stored on an information carrier, said program containing instructions enabling the implementation of the method of recording images composing a panorama in a digital image capture apparatus according to claim 1, when that program is loaded and executed by a computer system.

30. A computer program stored on an information carrier, said program containing instructions enabling the implementation of the method of viewing a panorama composed of digital images according to claim 15, when that program is loaded and executed by a computer system.

31. A computer program stored on an information carrier, said program containing instructions enabling the implementation of the method of modifying a panorama composed of digital images according claim 16, when that program is loaded and executed by a computer system.

32. A digital image capture apparatus, wherein it comprises a device according to claim 18.
